(19) United States
(12) Patent Application Publication
(10) Pub. No.: US 2006/0092325 A1
(43) Pub. Date: May 4, 2006

(54) Television display unit

(75) Inventor: Eduard W. Salomons, Dublin (IL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTROONICS N.V., EINDHOVEN (NL)

(21) Appl. No.: 10/538,094

(22) PCT Filed: Nov. 27, 2003
(86) PCT No.: PCT/IB03/05500

§ 371 Date: Jun. 8, 2005

(30) Foreign Application Priority Data
Dec. 13, 2002 (GB) 0229247.2

(51) Int. Cl. H04N 5/45

(52) U.S. Cl. 348/565

(57) ABSTRACT

A television receiver (1) has input circuitry (2) including tuners (3 and 4), hard disk unit HDD (5), all of which can input to demultiplex unit (6) and to the television monitor (7). A Picture-in-Picture facility is provided for specified channels for example with a common channel provider or with channels of related subject matter.

The present invention relates to television display units and methods of processing television signals.

Picture-in-Picture (or PiP) is a feature that allows the display of a smaller second video stream or still picture sequence in a corner of the main video picture. This second picture can e.g. be used to monitor one video stream while watching another.

PiP has been possible technically since the 1980's namely even when only analogue television signals were available. Even though it has proven to be a highly desirable feature, it has never reached mainstream products due to the associated cost. In particular, in an analogue TV, an expensive extra tuner, extra memory and an additional signal processing block is required to make the feature possible.

An object of the present invention may be to provide a television display unit allowing convenient use of the picture-in-picture capability, for example when an advertising break or programme break occurs.

Another object of the present invention may be to encourage the user to remain on associated channels, for example channels supplied by a single channel provider.

The present invention provides a television display unit comprising a receiver for a plurality of channels of television signals, means for displaying signals of a television channel, means for inputting signals of another television channel, means for displaying one channel as a reduced image additional to the main display, the main display channel and the reduced image channel being in a specified sub-set of the plurality of television channels.

Preferably the sub-set comprises the channels operated by one channel provider.

In this way, a viewer of the television display unit is encouraged to switch between channels available from the same channel provider when using the PiP facility while switching between channels in an advertisement break or programme break.

In another form, the specified sub-set may be channels of similar subject matter e.g. news channels, or sports channels, or comedy channels or they may be differing, for example a sports channel for the main display may be linked to a number of news channels for when an advertisement or programme break occurs.

In this way, the user has various predetermined channels to search through when advertisement/programme breaks occur.

The selection of channels can be determined by the user, or it can be pre-set or pre-programmed.

The television display unit may include any one or more of the following features:—
a first-displayed channel is displayed as the reduced image, and a second-displayed channel is displayed as a full image.
means to switch between channels of the sub-set to display a full image.
means to switch between channels of the sub-set to display a reduced image.
automatic means to continually switch between all the channels of the sub-set.
automatic means stops operation when a button for operation of the automatic means is released.
one of the channels is in an advertisement break or programme break.
the unit comprises means to detect when the channel is in an advertisement break or programme break.

The present invention also provides remote control apparatus to operate a television display of the present invention.

The present invention also provides a method of operating a television display unit comprising receiving a number of channels of television signals,

displaying signals of a television channel, inputting signals of another television channel, displaying one channel as a reduced image additional to the main display, the main display channel and the reduced image channel being in a specified sub-set of the plurality of television channels.

Another aspect of the present invention provides a computer program product directly loadable into the internal memory of a digital computer, comprising software code portions for performing the steps of the method of the present invention when said product is run on a computer.

Another aspect of the present invention provides a computer program for performing the steps of the method of the present invention when said product is run on a computer.

The present invention also provides a carrier, which may comprise electronic signals, for a computer program embodying the present invention.

The present invention also provides electronic distribution of a computer program of the invention.

In order that the invention may more readily be understood, a description is now given, by way of example only, reference being made to the accompanying drawings, in which:—

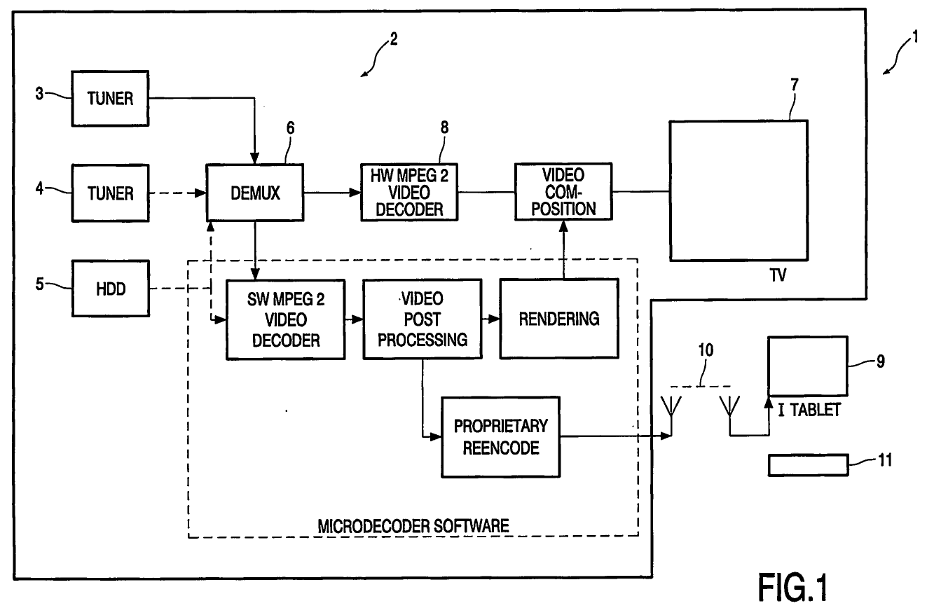

FIG. 1 is a television display unit embodying the present invention;

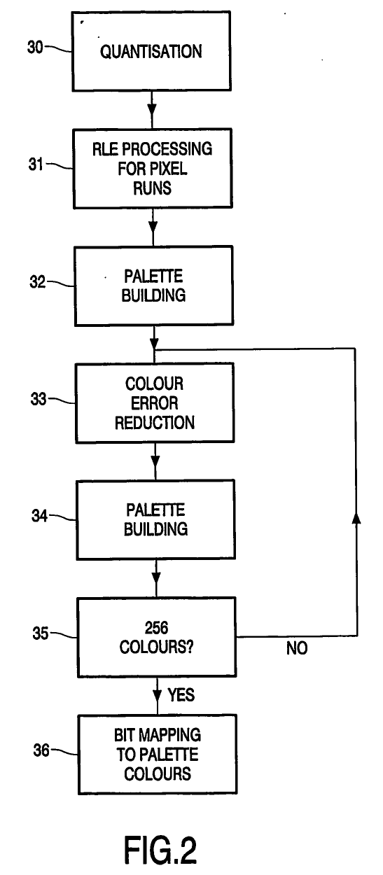

FIG. 2 shows stages in a conversion process.

The television display unit of the present invention involves a CPU on a MPEG video decoder to provide Picture-in-Picture (PiP) functionality, by decoding MPEG frames in software and rendering the decoded frame on top of the video plane.

In the present invention, the user is encouraged to switch between particular channels when an advertisement break or programme break occurs. The channels may be all related to a common channel supplier, or they can have the same type of content, or they can have some sort of relationship.

The television display unit reduces the frame rate of the PIP video, while eliminating the main cost factors, namely:
Memory: use of memory that is already available for a MPEG decoder.
Signal processing: all signal processing is done in the main CPU which is already available. Processing is done in the background in order to avoid use of other software running on the CPU.
Tuner: in television receivers with only one tuner, PiP is provided for a limited amount of channels, only those channels in the same transport stream (or TS) multiplex. Television receivers with PVR functionality (i.e. with hard-drive) use the PVR as a second video source, thus allowing for PiP of PVRITV content. Television receivers with a broadband modem can use streaming video streams as additional sources. Finally, television receivers with more than one tuner allow for unlimited TV PiP functionality.

DVB Video distribution uses a large number of separate frequencies (transponders) to send digital streams down from a satellite. On one such frequency, a limited amount of bandwith is available (typically 30-60 Megabit per second). The stream that is send on one frequency is called a transport stream (TS) and contains a multiplex of a number of programs, typically 4-10 programs (e.g. BBC1, BBC2, etc). Some broadcasters buy a transponder in a satellite and use the one TS to send all their programs out in the same TS on the same frequency.

In a set-top box with only one tuner, only one TS can be received at a time (to go to another one the frequency of the tuner needs to change). Thus if a person is watching a certain program on the main screen in a single tuner box, there is only access to video information for another program if this program is broadcast in the same TS. If one wants PiP for a program in a different TS, it is necessary to have a box with 2 tuners.

Data compression is the reduction of redundancy in data representation, carried out for decreasing data storage requirements and data communication costs. A typical video codec system is presented in FIG. 1, The lossy source coder performs filtering, transformation (such as Discrete Cosine Transform (DCT), sub-band decomposition, or differential pulse-code modulation), quantization, etc. The output of the source coder still exhibits various kinds of statistical dependencies. The (lossless) entropy coder exploits the statistical properties of data and removes the remaining redundancy after the lossy coding.

In MPEG, the DCT is used as a lossy coding technique. The DCT algorithm processes the video data in blocks of 8 8, decomposing each block into a weighted sum of 64 spatial frequencies. At the output of DCT, the data is also organized in 8 8 blocks of coefficients, each coefficient representing the contribution of a spatial frequency for the block being analyzed.

Following a zig-zag path, the matrix is transformed into a vector of coefficients, and further compressed by an entropy coder which consists of two major parts: Run-Length Coder (RLC) and Variable-Length Coder (VLC). The RLC represents consecutive zeros by their run lengths; thus the number of samples is reduced. The RLC output data are composite words, also referred to as source symbols, which describe pairs of zero-run lengths and values of quantized DCT coefficients. When all the remaining coefficients in a vector are zero, they are all coded by the special symbol end-of-block.

Variable length coding, also known as Huffman coding, is a mapping process between source symbols and variable length codewords. The variable length coder assigns shorter codewords to frequently occuring source symbols, and vice versa, so that the average bit rate is reduced. In order to achieve maximum compression, the coded data is sent through a continuous stream of bits with no specific guard bit assigned to separate between two consecutive symbols. As a result, decoding procedure must recognize the code length as well as the symbol itself.

In the present system, the MPEG encoder in the headend has used VLC to code symbols into a string of variable length bit-strings (e.g. symbols can be 2,3,4,5,16 bits long and are not byte aligned in the final stream). Even though they are not byte aligned, one can still find out where a new symbol starts because each symbol is unique.

In the MPEG decoder, it is necessary to read the stream bit-by-bit and derive the original symbols (run-length pairs) from it. This is called variable length decoding (VLD).

In order to achieve an acceptable performance (in terms of frames/MIPS), the microdecoder is specifically optimised for the PiP task. More specifically, it only decodes a few coefficients per DCT block, resulting in a reduced resolution for the output picture. It decodes I frames and only 3 out of the total of 64 coefficients in a DCT block, giving a factor 4 of reduction in resolution in both horizontal and vertical direction. There is no fundamental restriction for doing just I frames and the number of used coefficients/resolution can be changed according to the constraints.

The decoder performs the following actions:

1. It sets up demultiplexing to write the secondary video stream into a memory buffer.

2. It waits until there is an I frame in the buffer (a frame interrupt is used to signal the arrival of a new frame, the software in the decoder checks the frame header to determine if it is an I frame, otherwise it skips it).

3. It decodes the headers of the I frame until the first DCT block is found.

4. In the DCT block, a VLC decode for the first 3 coefficients is performed.

5. An inverse DCT is performed to obtain 4 pixel values per DCT block (which is very simple for only 3 coefficients).

6. A VLD operation must be performed for all coefficients that follow the third coefficient in the particular DCT block (even though they are not used in the IDCT and their value does not influence the pixel values), because of the way that MPEG works since the star of the next DCT block is not byte-aligned in any way. The only way to find the start of the next DCT block is to read away all VLD words of the previous DCT block.

7. This procedure is repeated for all DCT blocks in the frame, the resutling pixel values are written into a frame buffer.

8. If necessary, a filtering operation (post processing) is used on the picture in the frame buffer, in order to improve visibility of the PiP picture at normal viewing distances.

9. The picture in the resulting frame buffer is rendered onto the OSD plane (or Video/Still plane depending on the decoder).

For the VLD performed in step 6 above (which is the most processing-intensive operation in the entire decode process), the result of this VLD is not essential (it only being necessary to read the bits away to get to the next VLD word) to develop a faster VLD function. The speed improvement is obtained by reading away the bits in the VLD word as soon as the size of this VLD word is known, and omit looking up the runlength/value pair in a VLD table. This step is important for achieving a software decode performance to enable implementation at low cost.

Post Processing

Because the PiP picture has a reduced resolution and uses a lower frame-rate, sometimes it may be difficult to see what the image content actually represents. This is partly caused by the fact that the original video content was intended for a viewing distance of 3-5 times the image size.

In order to improve the visibility, a post-processing filter is used to adjust the contrast and brightness of the PiP picture, and thereby help recognition. In pictures with large areas that differ in intensity from each other, increasing the contrast can lead to unwanted effects. It is therefore desirable to adjust contrast/brightness differently on an image-segment by image-segment basis. For example, for a picture with a beach, a sea and a blue sky, there could be a different contrast/brightness adjustment for beach, sea and sky.

Rendering

The way in which the PiP image is displayed on top of the normal video depends on the type of MPEG Decoder that is used. The PiP image can be displayed in any of the following ways:—
The OSD (i.e. On Screen Display) plane;
A second video plane;
A still picture plane.

For the most popular decoder chip-sets and also for some other chip-sets, the order of the display planes is fixed and higher image planes conceal underlying planes. For such chip-sets, the still-picture plane is behind the video plane and the video plane is behind the OSD plane. Therefore it is not possible to use the still-plane for PIP (it is hidden behind the video plane).

The OSD plane is used for display of the PiP which requires the true-colour PiP Image (YUV) to be converted into a bitmap and mapped onto the available OSD palette (256 colours for the most popular chips). In fact, for acceptable picture quality, the palette must be selected and optimised on a picture-by-picture basis depending on the different colours in the picture. A few colours in the palette can be reserved to allow for specific OSD graphics to be displayed in another part of the screen while showing PiP.

The television receiver includes the following features:—

1. Decoding individual frames originating from a live video feed in a MPEG decoder, while simultaneously decoding a second stream in the hardware decoder.

2. Emulating a multi-screen decoder by decoding frames from a number of different streams, by decoding a single frame from one stream, then one from another stream, etc, then display the frames.

3. The optimised VLD operation for reading-away unused VLD words, in order to get to the start of the next DCT block.

4. The use of the OSD plane for showing PiP and the selection of the OSD palette depending on the image contents.

5. The use of a PVR as a second source with the PiP facility showing PVR content while watching TB or showing live TB while watching PVR.

6. The use of streaming video over a broadband connection as a second source.

7. Post processing to optimise the recognition of the content of the PiP pictures at normal viewing distances.

8. The generation of a Mosaic for an EPG by TDMA processing several channels.

Feature 5 may allow a viewer to watch a time-delayed version of a TV program coming from the PVR, while monitoring the live feed in a PiP window. Thus for example a viewer may start to watch a soccer match 30 minutes late, may catch up by fast forwarding selected parts of the beginning of the match, but in the meantime monitor the live match in the PiP in order to see whether there are any new goals).

When a break for advertisements occurs during the television program, PiP is often used by viewers for monitoririg (in the PiP window) the main program while the other TV channels for more interesting content. This could mean that offering PiP actually may result in a reduction of the exposure of viewers to commercials, which is bad for the service provider.

In the present invention, by only providing PiP for specified channels, for example those restricted to one or more service provider, viewing behaviour can be limited or restricted so that only switching between the specified channels (e.g. those of the service provider) is encouraged.

This operates as follows:

1. A viewer is watching a movie on SKY Movies.

2. At a certain moment, there is a commercial break.

3. The viewer switches away from SKY Movies, but keeps SKY Movies in a PiP window in order to monitor the progress of the commercial block while zapping.

4. When the viewer switches to a program in the SKY bouquet, the PiP window is present.

5. However, when the viewer switches away to a free-to-air channel, the PiP window disappears.

6. Since he is interested in watching the rest of the movie, this encourages the viewer to watch only other SKY channels while waiting for the commercial block on SKY Movies to end.

7. Because of this, the risk of the viewer permanently switching away to a channel owned by another service provider is reduced.

In a low-cost box with a single tuner and no PVR, PiP is only available for channels in the same TS multiplex. If all programs in the multiplex are owned by the same service provider, then the “loyalty PiP” strategy as outlined above is a useful feature that results directly from the single-tuner restriction.

With reference to the specific implementation described in relation to the Figures, FIG. 1 shows a television receiver 1 having input circuitry 2 including tuners 3 and 4, hard disk unit HDD 5, all of which can input to demultiplex unit 6 and to the television monitor 7.

The MicroDecoder unit 8 receives real-time MPEG2 video data from the demux 6 or MDD units. It decodes the MPEG2 video stream, performs post-processing to optimize the picture quality and outputs the video pictures to a TV or to a companion device via a wireless link.

For display on a TV, the video data is rendered onto a second video plane, an OSD plane or a still-picture plane, depending on the available resources in the video composition block of the decoder. Before output to a companion device 9 via a wireless link 10, the video data is re-encoded using a proprietary compression scheme in order to minimise the data rate on the wireless link and maintain the picture quality.

Operation of the PiP facility is by use of remote control unit 11 with appropriate command signals for microdecoder unit 8 and ancillary equipment.

The microdecoder unit 8 is a MPEG2 video decoder with software capability, and frame-rate and resolution are targeted at monitoring of secondary video streams. The memory footprint and processing load are highly optimised for deployment in low-cost set-top boxes. The decoder 8 has flexible real-time requirements in order to allow for easy integration with existing STB software and comes with associated chip-specific MPEG frame-capture and rendering modules.

The decoder 8 enables monitoring of secondary live video channels e.g. for monitoring main channel when switching during a commercial, or monitoring major events other channels, allowing for second channel monitoring, multi channel monitoring or Mosaicing for advanced channel surfing.

It allows monitoring of secondary video streams while using a PVR, e.g. for monitoring a channel that is being recorded while watching another channel. Monitoring the live video feed while watching a time shifted version, browsing PVR content while watching a live video channel, building a mosaic for browsing PVR content.

Furthermore, it enables off screen video monitoring using a TV companion device.

The MicroDecoder unit 8 fully complies with the MPEG2 video standard including different image sizes and frame rates, filed+frame coding, both can patterns, different quantization matrices, yet it was designed for seamless integration with existing STB software.

This means it provides, low processor load, flexible real-time requirements, can run in the background, so it won't disturb other tasks, small ROM footprint, small RAM footprint.

The television receiver includes acquisition and rendering modules for specific decoder architectures, or a decoding core, optimised in assembly for a specific processor, or integration of the MicroDecoder with existing STB SW “set-top box” software, for systems for several middleware standards like OpenTV, NDS, Microsoft TV and MediaHighway.

In an implementation of the present invention, one can switch between each of the, for example, 20 channels, but the PiP facility is not available for channel providers other than that of the principal channel currently being viewed. In this way, the viewer is encouraged to check only those channels associated with the same channel provider, in this instance C2 to C4 because he still wants to monitor C1.

For example, consider Sky Sports. Sky has a single tuner box with ST chip. Sky could upgrade the SW in their boxes (remotely) to offer a feature that allows a viewer to watch one Sky Sports channel (say Sky Sports 1 or SP1) while monitoring any of the 2 other Sky Sports channels in a PiP window.

User scenario: While watching SP1, the user presses the PiP button on the remote and the SP2 and SP3 show up in separate PiP windows. Repeated presses on the PiP window toggles between
SP2 PiP only,
SP3 PiP only,
No PiP,
SP2+SP3 PiP.

While PiP is on, channel up/down only changes between SP1, 2, and 3. In this mode, the PiP version of the channel that is watched on the main screen disappears or is replaced e.g. as follows:—

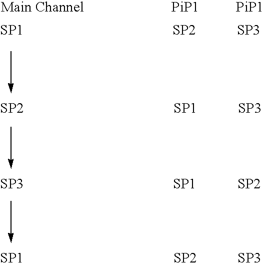

Note that, once PiP is switched off (by pressing “PiP” repeatedly), channel up/down allows access to all Sky channels again.

The steps of implementing another embodiment of the invention are as follows:—

1. A person is watching a program on Channel 1 (hereinafter known as C1).

2. An advertisement break or the programme end occurs.

3. He reduces C1 to PiP.

4. He puts the main image to C2, or the step of 3 above automatically replaces C1 with another channel e.g. C2.

5. He switches the main image from C2 to C3.

6. He switches the main image from C3 to C4.

7. He switches the main image from C4 to C1 (a feature of the invention being that there are no further channels to choose from, albeit the television receives 20 channels in total, but all the others are from different channel providers from that of C1 to C4).

In a variant, he presses a button for “auto switch” which replaces step 3 above by reducing C1 to PiP and then automatically switching between C2 to C4 continuously, stopping at each for 5 seconds. The sequence is stopped by pressing the button again. Alternatively, the switching occurs while the button is depressed and stops once the button is released.

The chip looks for an action being a reduction to PiP followed within a specified period, for example 5 seconds, by at least one switching. In a variant, the chip detects that C1 is in an ad break or a programme break. In another variant, there is provided a statistical analysis, for example, if the viewer watches C1 continuously for 25 minutes, one can deduce that there is something of interest, and so a channel change after that period of time would probably be during a commercial break, or just a switch to check for anything else. If the user is switching fast (e.g. there being less than 10 seconds between channel changes), the user is actually checking on what is presently on all the other channels.

Further developments are as follows:—

1. Using a plurality of PiP images of alternative channels provided by the same channel provider. C1 can either be kept as the main image, or as one of the PiPs while highlighted in some way, for example with a white boarder.

2. Auto-switching between C2 to C4 with e.g. 5 second periods for channel while displayed. This auto-switching can be used in any version of the invention to provide switching between the channels of the same channel provider.

A multi-PiP user scenario for the original case of unlimited channel changes could e.g be:

A commercial break starts while watching a soccer match on Sky Sports 1.

The user presses the PiP button once to indicate that he wants to keep monitoring this channel. The main screen keeps displaying SP1 and there is no PiP picture yet.

The user changes channels and the SP1 PiP appears on those channels that are in the same multiplex.

Pressing PiP while a PiP window is present on the screen (e.g. in SP2) will disable the active PiP and remove the window.

Pressing PiP on any channel that doesn't show the PiP window (channel in different multiplex or PiP disabled) will disable the previous PiP if required and select that channel for PiP.

The conversion operation from full-colour video to palette-based video involves some detailed processing. A first implementation of this processing is a simple quantisation of the pixel YUV values by making the “least significant bits” zero (i.e. truncation) e.g. DIV by 16 gives Y=45=0b00101101 becomes Y=32=0b00100000.

The palette is built by progressing through the pixels and adding a palette entry for each pixel color that is not yet in the palette.

The quantization limits the total amount of different colors in the total picture, so that most of the pictures have less than 256 different colors. In the initial implementation, if a picture has more than 256 colors, it is not displayed and the next one is taken.

A further-refined implementation as shown in FIG. 2 consists of the following steps:

1. Quantization as above, operation 30. Then there is an initial performing of a very rough quantization (e.g DIV 64), to guarantee that a palette with <256 colors is found;

2. Run-length-encoding of the quantized pixels to form pixel-runs, operation 31. Because there are less pixel-runs (groups of pixels with the same value) than pixels, this will speed up the rest of the processing;

3. Building an initial palette, operation 32;

4. Determining for which of the colors in the “rough” palette after step 1 above the total quantization error for all pixels that use that particular palette entry is the largest, operation 33. So, calculations are made for each of the colors i in the palette ERR[i]=SUM(palette_color[i]-color[j]), where j runs over all the pixels that use palette entry i. For the color in the palette which has the largest total error, the quantization level is reduced e.g. to DIV 32.

5. Building a palette, operation 34.

6. Steps 4 and 5 are repeated until 256 colors is reached, operation 35.

7. Finally, the pixels are mapped to the palette colors (bitmapping) so that pixel values are replaced by palette indices, operation 36. Because the palette was ordered in the previous steps, it is feasible to use a fast binary search to find what palette entry the pixel is mapped to. The palette is ordered in Y, U, V, e.g. color 100 90 70 is larger than 90 100 100 because the Y value is larger, so it is higher up in the palette.

It is also possible to do the pixel mapping right after quantization, after steps 2 and after 4 (in the refinement loop).

It is necessary to make optimal use of the spatial correlation between pixels. So, if a pixel has to be mapped, it is likely it has the same color as its predecessor, and therefore doing a full palette search for an individual pixel is on average not efficient. It is beneficial to run-length encode the picture before processing so that one can perform operations for groups of pixels. This means building up an array with (runlength, pixel_value) pairs starting with a simple horizontal line-based scan.

The situation can be simplified by defining the ultimate goal as obtaining a minimum for the sum of color-errors over the picture. The most fast error measure is probably the 3D sum of absolute differences, so GOAL: Minimize Sum(|Yn*-Yn|+|Vn*-Vn|+|Un*-Un|) with 0<n<N with * denoting approximation and N the number of pixels in the picture.

It is possible to use a hierarchical approach, starting with quantization by 32 and building an initial palette with binary search used to avoid duplication in the palette. Assume this palette will never overflow. An initial bitmap is generated using these rough colors, which can be done fast because the exact color is known is in the palette.

When building up the palette, the total error is maintained for each of the colors in the palette by calculating the color error for each and every pixel and adding it to the total of the particular color. This total error is the sum of the errors of all the pixels (or better: runlength groups of pixels) that have been assigned a particular color.

One can start refining the colors, beginning with the entry in the palette for which the total error is largest. For this palette entry, new mapping is done with quantization factor of 16 (so possible up to 8 colors come out of the 1 original rough color), and the error totals for the new colors are updated. This step includes updating the corresponding entries in the bitmap.

This operation is repeated (for the area with the largest error) until the palette is full, going to Q=8 if a color with Q=16 becomes the worst.

Steps that merge colors with a very small error back to a rougher color may be added in order to prevent that a few odd pixels take up a precious color (e.g. only accepting 64 colors in the first Q=32 step).

1. A television display unit comprising a receiver for a plurality of channels of television signals,
means for displaying signals of a television channel,
means for inputting signals of another television channel,
means for displaying one channel as a reduced image additional to the main display,
the main display channel and the reduced image channel being in a specified sub-set of the plurality of television channels.

2. A unit according to claim 1 wherein the sub-set comprises the channels operated by one channel provider.

3. A unit according to claim 1, wherein a first-displayed channel is subsequently displayed as the reduced image, and a second-displayed channel is displayed as a full image.

4. A unit according to claim 3 comprising means to switch between channels of the sub-set to display a full image.

5. A unit according to claim 3 comprising means to switch between channels of the sub-set to display a reduced image.

6. A unit according to claim 4 comprising automatic means to continually switch between all the channels of the sub-set.

7. A unit according to claim 6 wherein the automatic means stops operation when a button for operation of the automatic means is released.

8. A unit according to claim 1 wherein one of the channels is in an advertisement break or programme break.

9. A unit according to claim 1 wherein the unit comprises means to detect when the channel is in an advertisement break or programme break.

10. A television display unit substantially as hereinbefore described with reference to and/or as illustrated in any one or more of the Figures of the accompanying drawings.

11. A method of operating a television display unit comprising receiving a number of channels of television signals,
displaying signals of a television channel,
inputting signals of another television channel,
displaying one channel as a reduced image additional to the main display,
the main display channel and the reduced image channel being in a specified sub-set of the plurality of television channels.

12. A method according to claim 11 wherein the sub-set comprises the channels operated by one channel provider.

13. A method according to claims 11 comprising subsequently displaying a first-displayed channel as the reduced image, and displaying a second-displayed channel as a full image.

14. A method according to claim 13 comprising switching between channels of the sub-set to display a full image.

15. A method according to claim 13 comprising switching between channels of the sub-set to display a reduced image.

16. A method according to claim 14 comprising automatically continually switching between all the channels of the sub-set.

17. A method according to claim 16 comprising automatically stopping operation when a button for operation of the automatic means is released.

18. A method according to claim 11 wherein one of the channels is in an advertisement break or programme break.

19. A method according to claim 11 comprising detecting when the channel is in an advertisement break or programme break.

20. A method of operating a television display unit (1) substantially as hereinbefore described with reference to and/or as illustrated in any one or more of the Figures of the accompanying drawings.

21. A computer program product directly loadable into the internal memory of a digital computer, comprising software code portions for performing the steps of claim 11 when said product is run on a computer.
